(19) United States
(12) Patent Application Publication
(10) Pub. No.: US 2007/0210538 A1
(43) Pub. Date: Sep. 13, 2007

(54) Force sensor and manufacturing method for a force sensor

(76) Inventors: Werner Steprath, Dormagen (DE); Judith Dreyling, Schwieberdingen (DE); Peter Thierbach, Ludwigsburg (DE); Olaf Bartels, Bietigheim-Bissingen (DE)

Correspondence Address: KENYON & KENYON LLP, ONE BROADWAY, NEW YORK, NY, 10004, US

(21) Appl. No.: 11/707,706

(22) Filed: Feb. 16, 2007

(30) Foreign Application Priority Data
Feb. 17, 2006 (DE) 10 2006 007 385.1

(51) Int. Cl. B62B 15/00

(52) U.S. Cl. 280/1

(57) ABSTRACT

A force sensor has a cylindrically shaped housing which is elastically deformable by a force acting on it perpendicularly to its center axis. The housing has a hollow space. A measuring transducer device is situated in the hollow space, by which the deformation of the housing is able to be recorded. The measuring transducer device has a plate-shaped support plate on whose surface an expansion measurement transducer is fastened. The support plate is fastened in the hollow space in such a way that a deformation of the housing is transferred to the support plate.

### RELATED APPLICATION INFORMATION

The present application claims priority to German Patent Application No. 10 2006 007 385.1, which was filed on Feb. 17, 2006 in the German Patent Office, and the contents of which are hereby incorporated by reference.

### FIELD OF THE INVENTION

The present invention relates to a force sensor.

### BACKGROUND INFORMATION

A force sensor is used, for instance, in tractors. There it is used as a joint bolt for fastening the lower linkage on the tractor and measures tensile force or shear force acting on the lower linkage. Other fields of application are, for instance, load measurement in hay balers or stacker trucks. Such a usual force measurement bolt is discussed in German Patent document no. DE 30 04 952 A1. The force measurement bolt has a housing shaped like a hollow cylinder. A magnetic measuring transducer is set into the end face of the housing opening, and it records a mechanical load of the housing. The magnetic measuring transducer is equipped with a primary coil and two secondary coils, and it measures a magneto-elasticity of the housing material that changes under shear stress or tensile stress.

Such a usual force sensor may operate reliably, but it requires much effort and expenditure to produce.

It is an object of the exemplary embodiment and/or exemplary method of the present invention to provide a simply constructed and cost-effectively producible force sensor, which, in particular, is usable as a joint bolt.

This objective is attained by a force sensor having the features set forth in Claim 1. The object is further attained by the manufacturing method for a force sensor shown in Claim 19.

The force sensor according to the exemplary embodiment and/or exemplary method of the present invention has a cylindrically shaped housing which is elastically deformable by a force acting on it perpendicularly to its center axis. The housing has a hollow space. A measuring transducer device is situated in the hollow space, by which the deformation of the housing is able to be recorded.

The specialty of the exemplary embodiment and/or exemplary method of the present invention is that the measuring transducer device has a plate-shaped supporting plate on whose surface an expansion measurement transducer is fastened, and the support plate is fastened in the hollow space in such a way that a deformation of the housing is transferred to the support plate.

The force sensor according to the exemplary embodiment and/or exemplary method of the present invention is reliable, and is also particularly easy to manufacture. Expansion measurement transducers are proven measurement transducers for mechanical deformations. Because of the fastening of the expansion measurement transducer on a support plate, that latter is particularly easy to position in a housing hollow space using little mounting effort. For instance, it is substantially easier to fasten the support plate in the hollow space than fastening the expansion measurement transducer directly to an inner wall of the housing. In addition, the support plate permits positioning the expansion measurement transducer in a position and alignment that is optimal for the desired force measurement direction, without requiring a complicatedly shaped hollow space. A limited longitudinal section may be provided as a recording section for shear forces. In addition, the support plate transfers the mechanical deformation of the housing to the expansion measurement transducer, selectively as to direction, so that a preferred force measurement direction is specifiable. Thus, interference effects are reduced. The support plate itself is manufactured very simply, for example, as a sheet metal punched part. Because of its positioning in the hollow space, the expansion measurement transducer is well protected from soiling.

According to a further aspect of the exemplary embodiment and/or exemplary method of the present invention, during manufacturing of the force sensor, the support plate is made oversized compared to the hollow space. The support plate is fastened in the hollow space by having the hollow space elastically expanded in a direction perpendicular to the center axis of the housing by the action of an outside force, by setting the support plate into the expanded hollow space and by clamping the support plate into the hollow space in response to unstressing the hollow space. This makes for an especially simple and durable fastening of the support plate in the hollow space.

Advantageous further refinements of the exemplary embodiment and/or exemplary method of the present invention are indicated in the dependent claims.

According to one preferred specific embodiment, the support plate has an edge at which it is connected with force locking and/or with form locking to an inner wall of the hollow space. This simple construction permits tranferring tensile stresses or shear stresses, generated by shear forces at the housing, to the support plate and measuring them at its surface. There also takes place a distinct selection of direction, since shear forces, that are directed parallel to the surface of the support plate, trigger a clearly greater mechanical stress on the surface of the support plate than those that are directed perpendicular to the surface of the support plate.

An especially simple and reliable fastening of the support plate in the hollow space is achieved if the support plate is clamped into the hollow space between opposite sections of the inner wall. This type of fastening ensures good coupling of mechanical stresses over the edge of the support plate.

However, reliable fastening of the support plate and good coupling of the stress can also come about if the edge section of the support plate is adhered, soldered or welded to the inner wall of the hollow space.

The coupling of a shear force, acting parallel to the surface of the support plate, onto the support plate is further optimized if the surface of the support plate is aligned parallel to the center axis of the housing, and the center axis runs through end face edge areas of the support plate.

In one arrangement in which the expansion measurement transducer is situated at an angle of 45° to the center axis of the cylindrically shaped housing, one may expect an especially rough signal level swing of the measuring signal, since shear stresses generated by shear forces manifest themselves by an elongation or compression of a diagonal line of the deformed cylinder section.

In order to reduce interference signals, the expansion measurement transducer is held preferably in the region of a neutral axis with regard to a bend in the housing.

According to one preferred design, because of a stud on the support plate and because of a bulge in the housing, that accommodates the stud, an angular position of the support plate in the housing is uniquely specified. This ensures a mounting of the support plate that is true to position. Consequently, a force measuring device can be fastened ahead of time, and preselected by an outer design of the housing, for instance, an outer antirotation device.

Additional embodiments make production considerably simpler. Thus, for example, the hollow space preferably has the form of a blind-end bore or through-hole starting from an end face of the cylindrically shaped housing and executed along the center axis. It is also advantageous if the measuring transducer device has a plug for inserting into the receiving bore hole, that is, the blind-end bore or the through-hole, at which the support plate is affixed in the form of a protruding tab (tongue). Because of that, the support plate is able to be mounted in one work step together with a plug for closing up the receiving bore. In the case of a blind-end bore, no further work steps for closing up the receiving bore are required. The preassembled unit made up of plug and support plate is also easy and efficient to handle. In addition, one may position an electronic system in the plug, for evaluating a signal of the expansion measurement transducer. One thereby obtains a compact measuring transducer unit which is easy to mount, and supplies the stable measuring signals suitable for the vehicle. If a stop is developed on the plug or by a step in the receiving bore, with respect to the depth of insertion of the plug or the support plate, a longitudinal section of the force sensor may be generated reproducibly, in which the shear forces are able to be recorded, and consequently a manufacturing tolerance in the specimens can be eliminated during manufacturing.

One force sensor that is especially easy to produce is distinguished by having the support plate essentially in the form of a rectangular disk, and, at its longitudinal edges, that run parallel to the center axis of the housing, it is connected to the inner wall of the blind-end bore or the internal wall of the through-hole bore. In the case of this design, the recording range for shear forces is limited to a short longitudinal section of the housing, in which the expansion measuring transducer is also situated. Because of that, interfering influences can be reduced.

According to one especially preferred embodiment, the support plate has a taper in its width, in a region in which the expansion measurement transducer is situated, so that in the region of the taper, there is a gap between the longitudinal edges and the inner wall of the blind-end bore or the inner wall of the through-hole bore. Because of that, shear stresses, or a diagonal extension, triggered by shear stresses, in the support plate to the region in which the expansion measurement transducer is fastened, are able to be concentrated. Thus the signal level swing is improved. Furthermore, the force sensor has a somewhat wider recording section for shear forces. The width of the recording section is able to be set by the length of the tapered section.

Within a shear measuring zone of the support plate, if two expansion measurement strips, that are wired like a half bridge, are positioned perpendicular to each other, among other things, interference effects based on temperature fluctuations are able to be compensated for, perpendicular to the surface of the support plate.

According to an additional preferred embodiment, inside of a shear measurement zone of the support plate, four expansion measurement strips, wired like a full bridge, are positioned pair-wise on opposite surfaces of the support plate, perpendicular to each other. Using this arrangement, one obtains a greater signal amplitude, and torsional stresses are also able to be compensated for.

An additional advantageous embodiment provides that, within two shear measurement zones, having a clearance from each other in the longitudinal direction of the housing, in each case two expansion measurement strips are situated perpendicular to each other, and that these four expansion measurement strips are wired in one full bridge in such a way that shear forces, recorded in the two shear measurement zones, are added as long as they act in the same direction. This makes it possible, in the case of a bolt supported on two sides, to record the sum of the forces occurring at the two support bores. Consequently, a load distribution possibly failing asymmetrically because of wear in the bearings does not lead to a corruption of the measuring result.

In manufacturing the force sensor, the force effect is preferably directed at the elastic deformation of the housing, perpendicular to a surface of the support plate. Since the force to be measured is directed in parallel to the surface of the support plate, no widening of the hollow space takes place transversely to the support plate thereby, even at a great overload. Thus one is able to achieve a steadily reliable fastening of the support plate in the housing.

The exemplary embodiment and/or exemplary method of the present invention and its advantages are described in greater detail herein, including with reference to the exemplary embodiments shown in the figures.

### BRIEF DESCRIPTION OF THE DRAWINGS

FIG. 1 shows a schematic representation of a tractor having a plow that is held on a rear hoisting gear, and having a force measurement device which records a shear force or a tensile force at a bearing of the lower linkage.

FIG. 2 shows a section in the region of the bearing of the lower linkage, along sectional line A-A, having a force measurement bolt mounted into the bearing bores on the fastening arm, and a measuring transducer insert according to a first specific embodiment of the present invention.

FIG. 3A shows a measuring transducer insert as used in the force measuring bolt shown in FIG. 2.

FIG. 3B shows a section through the force measurement bolt along line C-C in FIG. 2 in an enlarged illustration.

FIG. 4 shows the fastening of the support plate during production of the force measurement bolt with the aid of a schematic cross section through the force measurement bolt.

FIG. 5 shows a comparable section to the illustration in FIG. 2, in which, according to a second specific embodiment of the present invention, the support plate of the measuring transducer insert is designed to be waist-shaped in the region of the shear measuring zone.

FIG. 6 again shows a comparable section to the illustration in FIG. 2, in which, according to a third specific embodiment of the present invention, shear stresses are able to be recorded in two shear measuring zones on a support plate of the measuring transducer insert.

### DETAILED DESCRIPTION

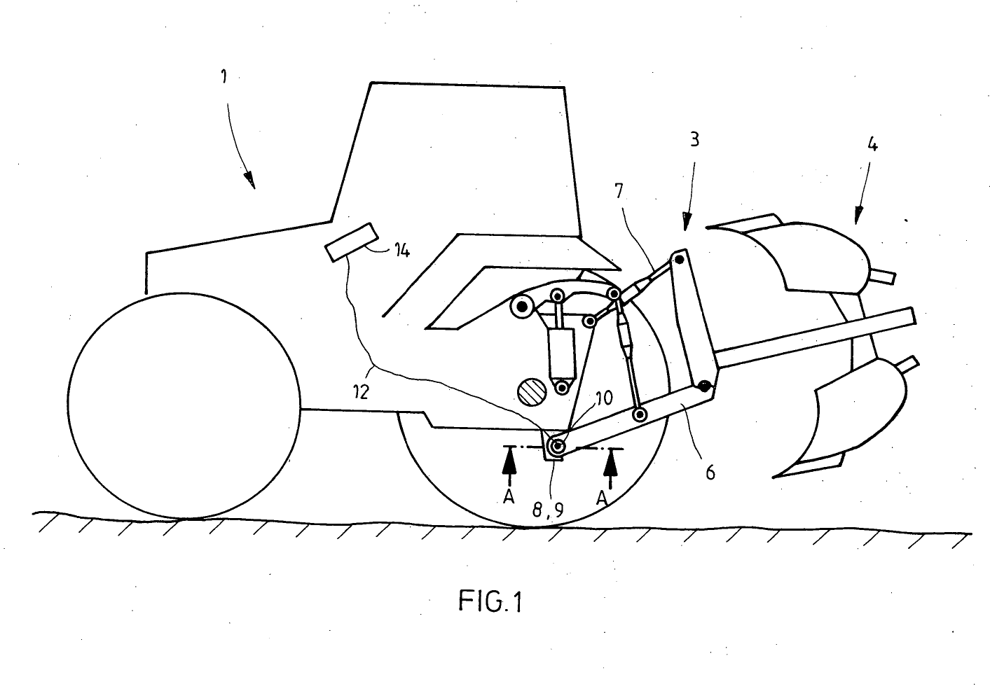

In a schematic representation, FIG. 1 shows a tractor 1, at whose rear end a hoisting gear 3 having a plow 4 is held. Hoisting gear 3 is supported via various linkages on the rear end of tractor 1. Of these linkages, one lower linkage 6 and one upper linkage 7 are shown in FIG. 1. Lower linkage 6 is held at two fastening arms 8, 9 of tractor 1. On lower linkage 6, an attachment such as plow 4 is held. Lower linkage 6 is fastened by a joint bolt 10 to fastening arms 8 and 9. Joint bolt 10 is provided with a force measurement device, by which a shear force or a tensile force on lower linkage 6 is recorded. Joint bolts 10 having an integrated force measurement device are also designated as force measurement bolts. A signal corresponding to a measured force is transmitted to a control unit 14 via a signal line 12. Control unit 14 controls, for example, hoisting gear 3, in order to regulate the depth of penetration of plow 4.

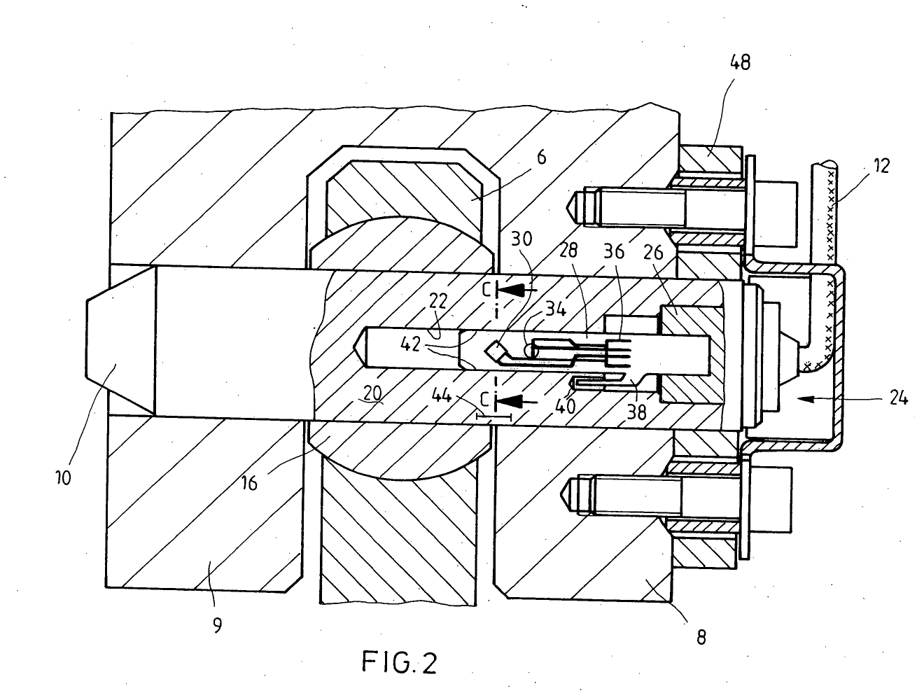

The region in which lower linkage 6 is fastened to fastening arms 8 and 9 using force measurement bolt 10 is shown more precisely in FIG. 2, in a section along line A-A. Force measurement bolt 10 is set into receiving bore holes in fastening arms 8 and 9. A mounting support 48 is fastened to force measurement bolt 10. By using mounting support 48, force measurement bolt 10 is torsion-proof and held in the receiving bore holes at a specified insertion depth. Via linear ball bearing 16, lower linkage 6 is held rotatably between fastening arms 8 and 9 on force measurement bolt 10.

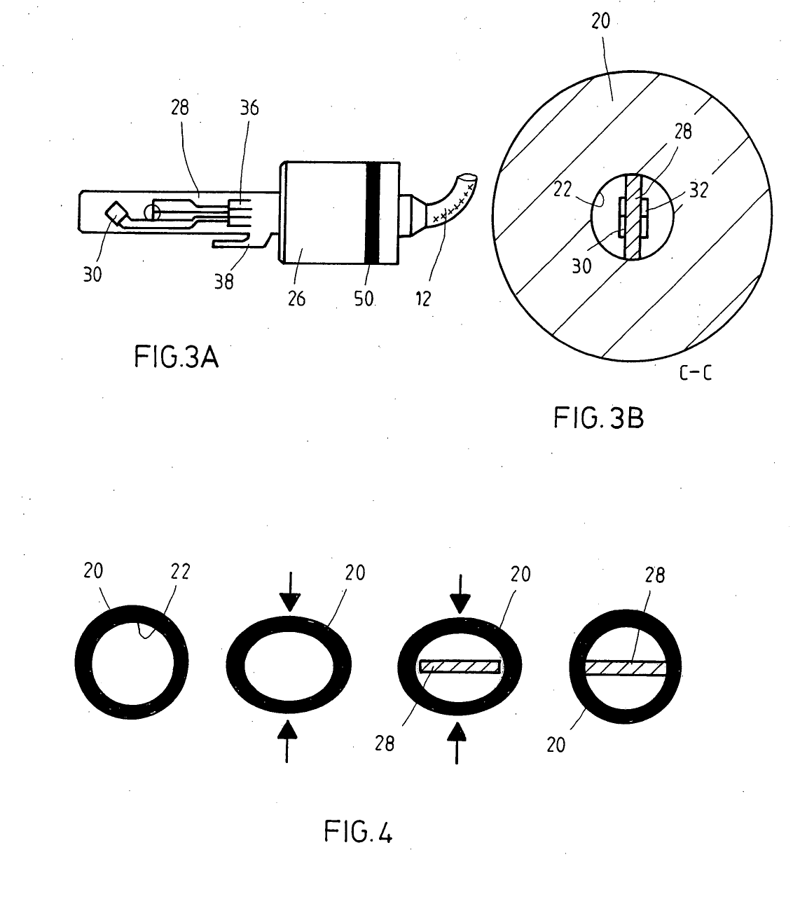

Force measurement bolt 10 has a cylindrically shaped housing 20 into which a stepwise blind-end bore 22 has been inserted at the end face. A measuring transducer insert 24 is fastened in blind-end bore 22. In FIG. 3A, measuring transducer insert 24 is shown by itself. It forms a premounted assembly which is fastened in blind-end bore 22 of housing 20. Measuring transducer insert 24 has a plug 26 and a plate-shaped support plate 28, which is joined to plug 26 in the form of a (tongue-shaped) tab. A sealing ring 50, which is situated in an encircling annular groove of plug 26, is used to seal blind-end bore 22. An amplifying electronic system is accommodated inside plug 26, and it outputs a measuring signal on signal line 12. Plug 26 is supported on a step of bore 22, as is made clear in FIG. 2. Support plate 28 protrudes into blind-end bore 22, starting from plug 26. Support plate 28 is situated parallel to the center axis of housing 20, and is crossed by the center axis in its longitudinal direction. On its front side, that faces the observer in FIG. 2, it is equipped with an expansion measurement strip 30. Expansion measurement strip 30 is aligned at an angle of 45° diagonally to the center axis of the housing, and it is adhered to the support plate over its whole surface. On the rear side of support plate 28, opposite to expansion measurement strip 30, an additional expansion measurement strip 32 is adhered on. The latter is rotated by 90° to expansion measurement strip 30. FIG. 3B shows a section through force measurement bolt 10 along with inserted measuring transducer device 24 along sectional line C-C in FIG. 2. One may recognize support plate 28 that is fastened in the middle of blind-end bore 22, which is equipped on each side with expansion measurement strips 30 and 32.

As FIGS. 2 or 3A show additionally, connecting wires of expansion measurement strip 32 are guided via a bore 34 in support plate 28 to the front, and are connected together with the connecting wires of expansion measurement strip 30 to a connecting plug 36 that is shown only schematically. Expansion measurement strips 30 and 32 are connected via connecting plug 36 to the amplifier electronic system that is accommodated in plug 26. Expansion measurement strips 30 and 32 are wired as a half bridge. This permits the compensation for temperature-conditioned signal changes.

A stud 38 is joined laterally onto support plate 28. It engages in bore 40, which extends into housing 20, starting from a step in blind-end bore 22. Support plate 28 has the shape of an elongated, essentially rectangular plate. In a section facing away from plug 26, support plate 28 is fastened, at its edges 42 running in the longitudinal direction, to the inner wall of blind-end bore 22. This applies especially to the region in which expansion measurement strips 30 and 32 are adhered to support plate 28. In response to this arrangement, a longitudinal section of housing 20, in which expansion measurement strips 30 and 32 are situated, forms a recording section 44 in which force measurement bolt 10 is sensitive to shear forces. In recording section 44 a shear strain in housing 20 causes a deformation of the section of support plate 28 that is fastened in this region. Expansion measurement strips 30 and 32 record the diagonal elongation or compression of support plate 28 resulting from the shear stress in the region of recording section 44.

Mounting support 48 ensures that expansion measurement strips 30 and 32, and thus recording section 44, lie in one shear zone, in which linear ball bearing 16 and fixed fastening arm 8 cause a shear strain in force measurement bolt 10 in response to a force effect on the lower linkage.

Support plate 28, because of its positioning, is located on the center axis of housing 20, on a neutral axis with respect to a bending strain. Consequently, bending stresses are recorded in a very weakened manner, at all events. Besides that, the rotational angle alignment of support plate 28 is established by mounting support 48 and stud 38. Because of the positioning of support plate 28 and expansion measurement strips 30 and 32, shear forces are recorded that are, above all, directed parallel to the surface of the front or rear of support plate 28. Shear forces perpendicular to this surface result in an elongation of support plate 28 in the longitudinal direction, and are compensated for by the wiring configuration of expansion measurement strips 30 and 32 as a half bridge.

The front and rear sides of support plate 28 are usually aligned parallel to a horizontal line during use on a tractor, in order to measure as efficiently as possible the tensile forces acting by the attachment in the horizontal direction on force measurement bolt 10.

In light of FIG. 4 we shall now describe the fastening of support plate 28 in blind-end bore 22 of housing 20. The partial steps of the fastening procedure are shown going from left to right. In its width, support plate 28 is slightly oversized compared to the internal diameter of blind-end bore 22. By the exertion of a pressure force in a direction parallel to the front or rear side of support plate 28, housing 20 is elastically deformed to form an oval. This widens blind-end bore 22 in the direction of the width of support plate 28. Measuring transducer insert 24 is inserted, with support plate 28 ahead, into the deformed housing. Thereafter, the pressure on housing 20 is removed, and the latter returns to its original circular form. Thereby support plate 28 in blind-end bore 22 is clamped between opposite inner walls. This fastening permits the reliable transfer of shear forces, that is, shear strains and tensile strains in housing 20 on support plate 28. Alternatively, support plate 28 could also be welded, soldered or adhered at its longitudinal edges 42 to the inner wall of blind-end bore 22. However, this would cause a higher manufacturing expenditure.

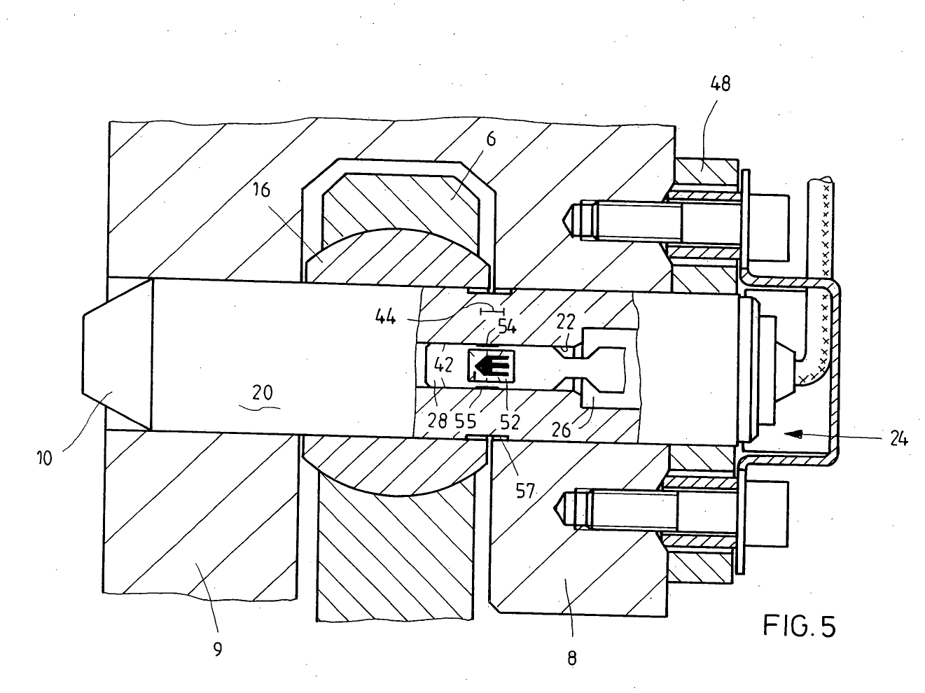

With the aid of the second specific embodiment of the present invention shown in FIG. 5, advantageous modifications are described of force measurement bolt 10 according to the exemplary embodiment and/or exemplary method of the present invention. These are able to be used by themselves and also in combination. The basic design corresponds to the first specific embodiment.

According to the second specific embodiment, in each case two expansion measurement strips are situated on the front and the rear sides of support plate 28. These are aligned rotated by 90° with respect to each other. The expansion measurement strips each include an angle of 45° with the center axis of housing 20. In the exemplary embodiment shown, the two expansion measurement strips are already situated together, at right angles to each other, on an expansion measurement element 52. This is adhered to the surface of the front side of support plate 28. A corresponding expansion measurement element is also applied to the rear side of the support plate, opposite to expansion measurement element 52. The overall total of four expansion measurement strips is wired to form a full bridge. Thereby, besides temperature-conditioned signals, torsion strains acting on force measurement bolt 10 are also able to be compensated for.

An additional modification relates to the shape of support plate 28. At its longitudinal edges 42 it is in each case provided with a recess 54 and 55. Because of that, there is a gap in each case between the inner wall of blind-end bore 22 and support plate 28. Recesses 54 and 55 are provided opposite to each other in the region of recording section 44. Support plate 28 is thus tapered in this region. The expansion measurement strips are situated inside the tapered longitudinal section of support plate 28. Because of the taper, there comes about an improved coupling of shear forces into support plate 28. The width of recording section 44 is able to be set by the length of recesses 54 and 55. In particular, a diagonal elongation or compression, caused by shear forces, is concentrated on the tapered longitudinal section of support plate 28. Consequently, the location for an optimal recording of the shear forces is constructively established. The expansion measurement strips are therefore able to be placed in an optimal manner using a small expenditure. In addition, recesses 54 and 55 have the effect that the measuring device from housing 20 and measuring transducer insert 24 is tolerant to a slight displacement of support plate 28 in the longitudinal direction.

Annular groove 57, which is formed to run around the outside of housing 20, has a similar effect. It has the effect of concentrating shear forces to the longitudinal section of housing 20 that is covered by it. Consequently, force measurement bolt 10 is more tolerant to a slight variation with respect to its depth of insertion.

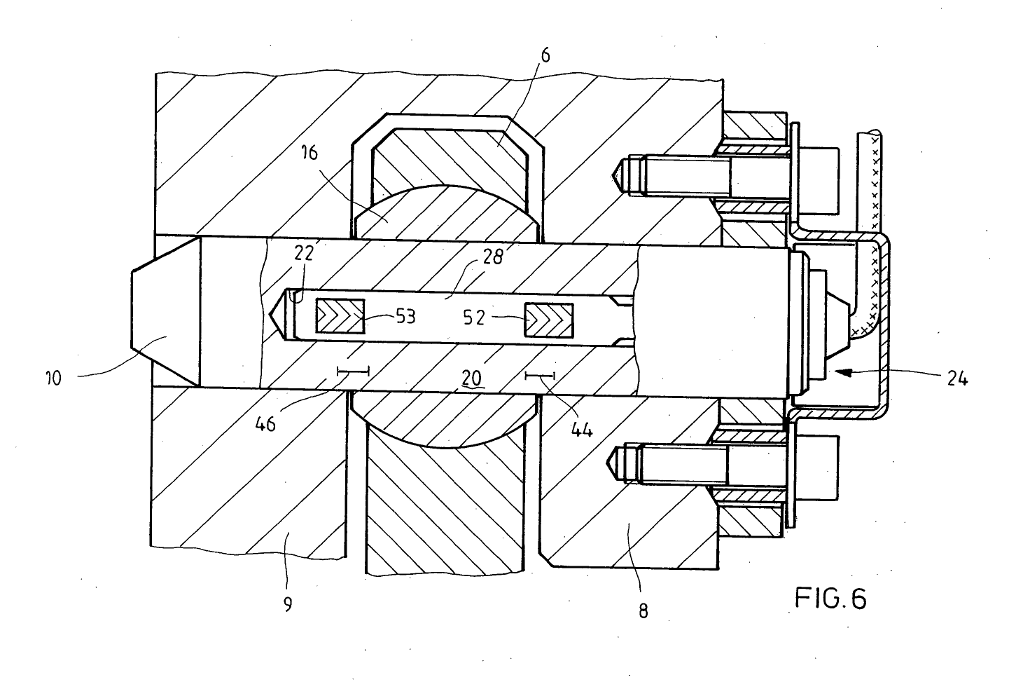

With the aid of the third specific embodiment of the present invention shown in FIG. 6, a further modification is described of force measurement bolt 10 according to the exemplary embodiment and/or exemplary method of the present invention. The basic design corresponds to the first specific embodiment.

Blind-end bore 22 in housing 20 is designed to be so long that it extends also to the second shear zone that is formed between linear ball bearing 16 and fastening arm 9. Support plate 28 also extends through both shear zones in the longitudinal direction. In addition to recording section 44, a further recording section 46 is formed, in which force measurement bolt 10 is able to record shear forces. In recording section 44, support plate 28 carries expansion measurement element 52. In recording section 46, an additional expansion measurement element 53 is fastened to support plate 28. On the two expansion measurement elements 52 and 53, two expansion measurement strips are integrated that are situated perpendicular to each other. The altogether four expansion measurement strips included in the two expansion measurement elements 52, 53, are wired up to form a full bridge. The wiring is carried out in such a way that equidirectional shear forces recorded in recording sections 44 and 46 are added together in the output signal of the full bridge.

The force exerted by lower linkage 6 on force measurement bolt 10 is usually applied half and half to fastening arms 8 and 9. This distribution is, however, able to change in response to asymmetrical wear of the receiving bores and of force measurement bolt 10. As a result, the shear forces appearing in the two shear zones are able to deviate from one another. By recording the sum of the shear forces acting in the two recording sections 44 and 46, one is able to determine the tensile force and the shear force acting upon lower linkage 6 very accurately and reliably.

The modifications of the second specific embodiment, especially the tapering of support plate 28 in the respective recording section, are also able to be applied to the third specific embodiment, without trouble.

A List of the reference numerals is as follows:
1 tractor
3 hoisting gear
4 plow
6 lower linkage
upper linkage
fastening arm
fastening arm
force measurement bolt
signal line
control unit
linear ball bearing
housing
blind-end bore
measuring transducer insert
plug
support plate
expansion measurement strip
expansion measurement strip
bore
connecting plug
stud
bore
longitudinal edge
recording section
recording section
mounting support
sealing ring
expansion measurement element
expansion measurement element
recess
recess
annular groove

What is claimed is:

1. A force sensor comprising:
a cylindrically shaped housing, which is elastically deformable by a force acting on it perpendicular to its center axis, and which has a hollow space; and
a measuring transducer device situated in the hollow space, by which a deformation of the housing is recordable;
wherein the measuring transducer device includes a plate-shaped support plate and an expansion measurement transducer fastened to a surface of the support plate, and wherein the support plate is fastened in the hollow space so that a deformation of the housing is transferred to the support plate.

2. The force sensor of claim 1, wherein the support plate includes an edge at which it is connected with at least one of force locking and form locking to an inner wall of the hollow space.

3. The force sensor of claim 2, wherein the support plate is clamped in the hollow space between opposite sections of the inner wall.

4. The force sensor of claim 2, wherein an edge section of the support plate is at least one of adhered to, soldered to or welded to the inner wall of the hollow space.

5. The force sensor of claim 1, wherein the surface of the support plate is aligned parallel to a center axis of the housing, and the center axis runs through edge areas at an end face of the support plate.

6. The force sensor of claim 1, wherein the expansion measurement transducer is situated at an angle of 45° to a center axis of the cylindrically shaped housing.

7. The force sensor of claim 1, wherein the expansion measurement transducer is held in a region of a neutral axis with respect to a bending of the housing.

8. The force sensor of claim 1, wherein an angular position of the support plate in the housing is uniquely specified by a stud on the support plate and by a bulge in the housing that accommodates the stud.

9. The force sensor of claim 1, wherein the hollow space has a form of one of a blind-end bore and a through-hole bore, starting from a side surface of the cylindrically shaped housing and carried out along a center axis.

10. The force sensor of claim 9, wherein the measuring transducer device includes a plug for insertion into one of the blind-end bore and the through-hole bore, at which the support plate is joined in the form of a protruding tab.

11. The force sensor of claim 10, wherein an electronic system for evaluating a signal of the expansion measurement transducer is situated in the plug.

12. The force sensor of claim 10, wherein a stop with respect to a depth of insertion of the plug and the support plate is formed one of on the plug and by a step in the blind-end bore or the through-hole bore.

13. The force sensor of claim 9, wherein the support plate includes a rectangularly-shaped plate, and at its longitudinal edges running parallel to the center axis of the housing it is connected to the inner wall of the blind-end bore or to the inner wall of the through-hole bore.

14. The force sensor of claim 13, wherein the support plate includes a tapering in its width in a region in which the expansion measurement transducer is situated, and wherein in a region of the tapering there is a gap between the longitudinal edges and the inner wall of the blind-end bore or the inner wall of the through-hole bore.

15. The force sensor of claim 1, wherein two expansion measurement strips that are wired up according to a half bridge within a shear measurement zone of the support plate are situated at right angles to each other.

16. The force sensor of claim 1, wherein four expansion measurement strips that are wired up according to a full bridge within a shear measurement zone of the support plate are situated pair-wise at right angles to each other on opposite surfaces of the support plate.

17. The force sensor of claim 1, wherein in each case two expansion measurement strips are situated at right angles to each other within two shear measurement zones at a distance from each other in a longitudinal direction of the housing, and these four expansion measurement strips are wired up in a full bridge so that shear forces recorded in the two shear measurement zones are added together, provided they are equi-directional.

18. A method for making a force sensor, the method comprising:
making a support plate oversized with respect to a hollow space of a cylindrically shaped housing;
fastening the support plate in the hollow space, wherein the hollow space is elastically widened in a direction perpendicular to the center axis of the housing by an action of an outer force; and
inserting the support plate into the widened hollow space;
wherein, when a tension of the hollow space is released, the support plate is clamped in the hollow space, and
wherein the force sensor includes:
the cylindrically shaped housing, which is elastically deformable by a force acting on it perpendicular to its center axis, and which has the hollow space, and
a measuring transducer device situated in the hollow space, by which a deformation of the housing is recordable, in which the measuring transducer device includes a support plate, which is a plate-shaped support plate, and an expansion measurement transducer fastened to a surface of the support plate, the support plate being fastened in the hollow space so that a deformation of the housing is transferred to the support plate.

19. The method of claim 18, wherein the action of a force for the elastic deformation in the manufacturing process is directed perpendicularly to a surface of the support plate.
